(19) United States
(12) Patent Application Publication
(10) Pub. No.: US 2019/0168886 A1
(43) Pub. Date: Jun. 6, 2019

(54) FUEL TANK WITH SUCTION SYSTEM

(71) Applicant: Airbus Operations SL, Getafe (ES)

(72) Inventor: Fernando ANGULO IBAÑEZ, Getafe (ES)

(21) Appl. No.: 16/205,918

(22) Filed: Nov. 30, 2018

(30) Foreign Application Priority Data
Dec. 1, 2017 (EP) 17382813.8

(51) Int. Cl. B64D 37/08; B64D 37/04; B64D 37/34

(52) U.S. Cl. CPC B64D 37/08; B64D 37/34; B64D 37/04

(57) ABSTRACT

A fuel tank with a suction system, comprising a flexible hose comprising first and second extremities, the second extremity comprising an orifice configured to be connected to a first orifice of a first pipeline via a connection point. The first extremity of the flexible hose is fastened to a floating system and comprises at least one orifice, such that the orifice is a suction point always able to supply the engine from an upper layer of fuel available inside the tank, to avoid water and dirt from the lower layer.

### CROSS-REFERENCES TO RELATED APPLICATIONS

This application claims the benefit of the European patent application No. 17382813.8 filed on Dec. 1, 2017, the entire disclosures of which are incorporated herein by way of reference.

### FIELD OF THE INVENTION

The present invention relates to a fuel tank with suction system. More specifically, the invention is relative to a Fuel tank with suction system able to feed an Auxiliary Power Unit.

### BACKGROUND OF THE INVENTION

An APU (Auxiliary Power Unit) is a gas turbine engine which is used in aircraft to provide electrical and/or pneumatic power to various aircraft systems and components. The APU is controlled and monitored by an ECB (Electronic Control Box).

When an aircraft is in ground mode, its main source of electrical power and compressed air for cabin conditioning is provided by the APU. The APU is able to power the aircraft and the ECS (Environmental Control Systems), drive the pneumatic starters systems for the MES (Main Engines Start). When an aircraft is in flight mode, the APU is able to provide pneumatic and/or electric power to the aircraft.

APUs are generally located in the aft fuselage module of the aircraft, at or near the tail cone section, but the APU is commonly fed in fuel via the wings tanks.

Indeed, nowadays, a suction point is fixed and located in the lower part of a fuel tank of each main wing, mainly to guarantee that the APU will be fed by fuel even with low quantity of fuel in the tanks.

However, some water enters into the aircraft fuel tanks with the uplifted fuel, when the fuel is mixed or dissolved, and during in-breathing, when humid air enters the tank as tank gauge decreases. During the descent of the aircraft, water vapor becomes liquid with the increase of ambient temperature.

For large range aircraft, with a huge wing tanks, this quantity of water can be several hundred liters.

Due to the differences of density between water and Jet fuel, because water is denser than fuel, water precipitates to the lowest parts of the tanks, creating at least several phases, a lower layer of water, an upper layer of fuel, and between these layers a slight mixed-phase.

Aircraft fuel tanks are drained of water on a regular basis, but sometimes the amount of water between draining tasks can be significant. Free water in the tanks can give rise to some problems of engine performance, specifically for APU engines because they are much more susceptible to water ingestion than main engines.

### SUMMARY OF THE INVENTION

In order to solve the drawbacks stated above, the present invention proposes that the APU be always supplied with the clearest, cleanest, and waterfree fuel from the upper level of the tank. The main advantage of the invention is to avoid suction from the lower area of the tank in which water and/or dirt tent to accumulate.

Another advantage of this invention, and not the least, is to keep the piping and the APU pump exactly as they presently are, but only adapt the current suction point. This would minimize the mechanical complexity and additional parts counts, the modifications required, and would be easy implementable to retrofit aircraft already on the market.

The present invention is relative to a fuel tank with a suction system, the tank comprising within at least two layers of fuel, with a lower layer being denser than the upper layer, the suction system comprising:
a first pipeline comprising, respectively, a first and a second extremity, the extremities each comprising, respectively, a first and a second orifice,
a second pipeline comprising, respectively, a first and a second extremity, the extremities each comprising, respectively, a first and a second orifice,
a third pipeline comprising, respectively, a first and a second extremity, the extremities each comprising, respectively, a first and a second orifice,
the second orifice of the first pipeline is connected to the first orifice of the second pipeline via a vacuum pump,
the second orifice of the second pipeline is connected to the first orifice of the third pipeline via a valve,
the first orifice of the third pipeline is connected to a fuel engine,

characterized in that, the suction system comprises:
a flexible hose comprising a first and a second extremity, the second extremity comprising an orifice configured to be connected to the first orifice of the first pipeline via a connection point,
the first extremity of the flexible hose being fastened to a floating system and comprising at least one orifice, the orifice comprising a suction point always able to supply the engine from the upper layer of fuel available in the tank, in order to avoid water and potential dirt from the lower layer.

According to the invention, the connection point is an articulation point, such that the hose is able to move freely with respect to the first pipeline;

According to the invention, the flexible hose is retractable, such as when the first extremity of the flexible hose is moving down according to the level of fuel available in the tank, the hose length is reducing, and when the first extremity of the flexible hose is moving up according to the level of fuel available in the tank, the hose length is increasing;

According to the invention, the floating system is a buoy;

According to the invention, the first extremity of the flexible hose is only able to move vertically via a fixed guiding element inside the tank, while the level of fuel available changes.

According to the invention, the guiding element can be a rail, a rod or a profile, made from metal or composite material.

According to the invention, the suction point of the first extremity of the flexible hose is located at some centimeters below the floating element, between 1 and 3 centimeters, in order to be sure that the suction point is fed with fuel air-free and dirt-free.

According to the invention, the tank can be housed inside an aircraft wing or a horizontal tail cone.

The present invention is also relative to an APU (Auxiliary Power Unit) fed with fuel via a fuel tank with suction system according to the present invention.

### BRIEF DESCRIPTION OF THE DRAWINGS

To complete the description and in order to provide for a better understanding of the invention, a set of drawings is provided. The drawings form an integral part of the description and illustrate preferred embodiments of the invention. The drawings comprise the following figures:

FIG. 1, is a schematic representation of a fuel tank with suction system according to the state of art;

FIG. 2, is a schematic representation of a fuel tank with suction system according to one embodiment of the invention;

### DETAILED DESCRIPTION OF THE PREFERRED EMBODIMENTS

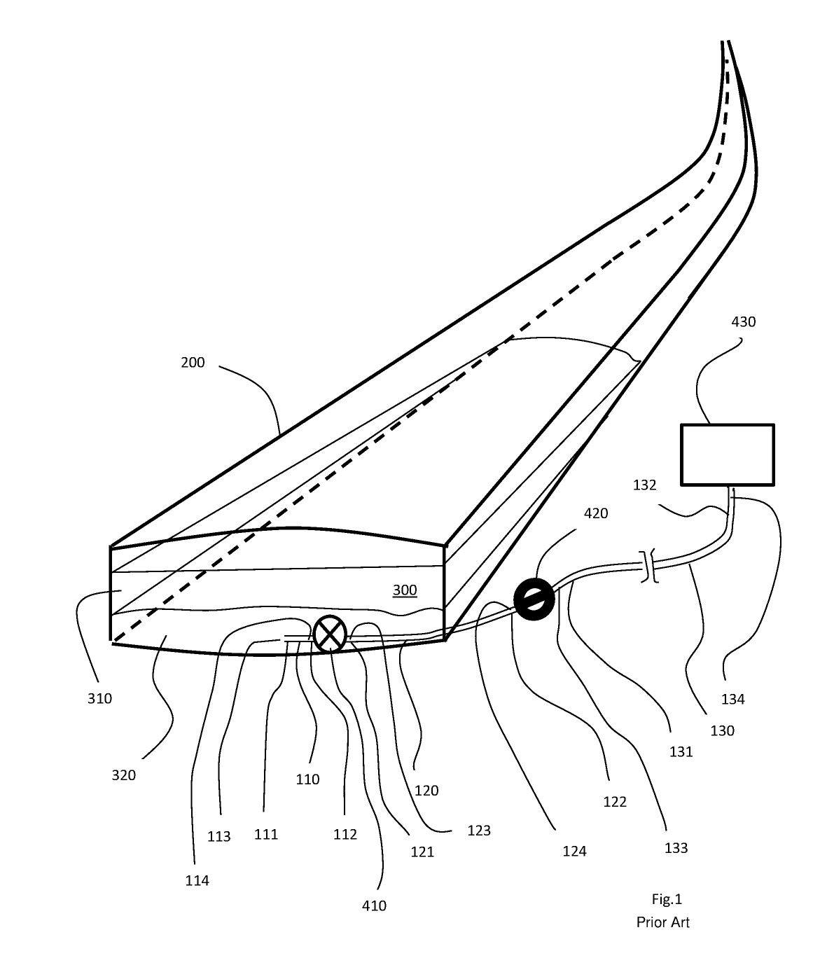

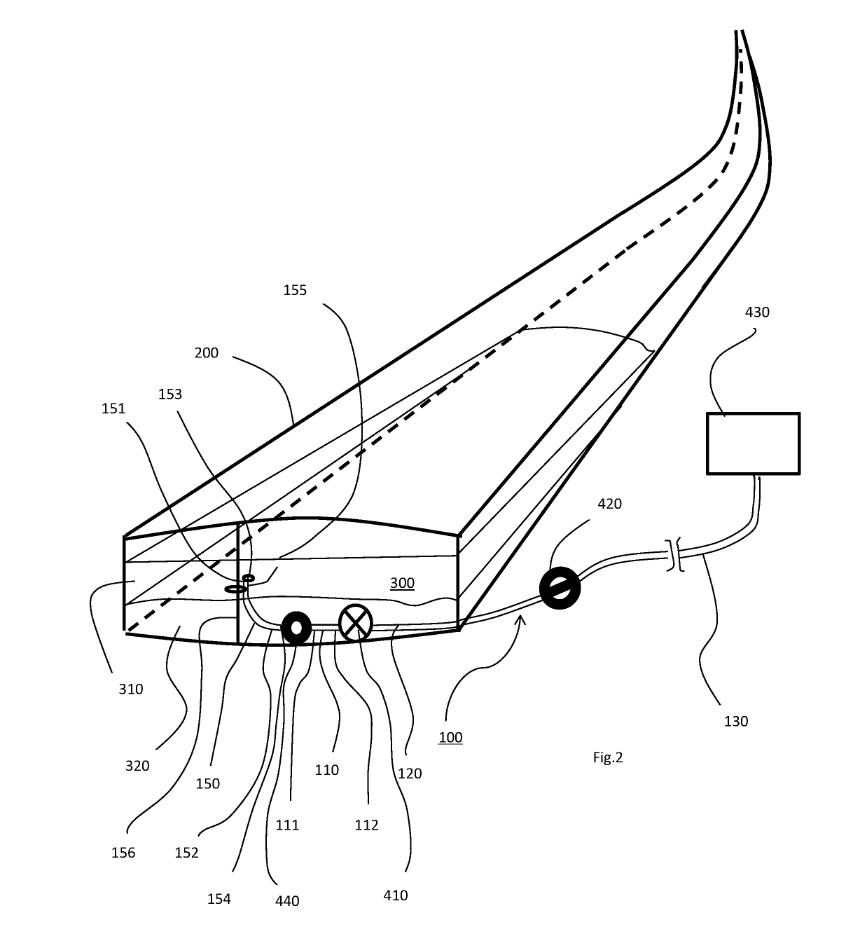

The present invention is directed generally toward a fuel tank with a suction system. A person skilled in the relevant art will understand, however, that the invention may have additional embodiments, and that the invention may be practiced without several of the details of the embodiments described below with reference to FIGS. 1 and 2.

FIG. 1 is a schematic representation of a fuel tank 200 with a suction system 100 according to the state of art. FIG. 1 describes a part of aircraft wing, comprising inside the fuel tank 200 in order to feed a set of thermic/fuel engines 430 of the aircraft. Indeed, in commercial aircraft, fuel tank 200 is usually housed in the main aircraft wing and/or in the (HTP) Horizontal Tail Plane. In a non-exhaustive list, the set of thermic engines comprises at least the main engines and additionally the (APU) Auxiliary Power Unit. In this schematic representation, the tank 200 is not fully filled and comprises at least two layers 310, 320 of fuel 300, an upper layer 310 and a lower layer 320. The lower layer 320 is water or a mixture of water with fuel which is denser than the upper layer 310 which is pure fuel. The suction system 100 of the state of art comprises a set of pipelines 110, 120, 130 such as a first pipeline 110 comprising respectively a first 111 and a second 112 extremity, the extremities 111, 112 comprising respectively a first 113 and a second 114 orifice. The suction system 100 comprises a second pipeline 120 comprising respectively a first 121 and a second 122 extremity, the extremities 121, 122 comprising respectively a first 123 and a second 124 orifice. The suction system 100 comprises also a third pipeline 130 comprising respectively a first 131 and a second 132 extremity, the extremities 131, 132 comprising respectively a first 133 and a second 134 orifice.

The set of pipelines 110, 120, 130 are successively connected together, such as the second orifice 114 of the first pipeline 110 is connected to the first orifice 123 of the second pipeline 120 via a vacuum pump 410. The second orifice 124 of the second pipeline 120 is connected to the first orifice 133 of the third pipeline 130 via a valve 420. The first orifice 133 of the third pipeline 130 is connected to a set of fuel engines 430, such as the APU (Auxiliary Power Unit) and/or the main aircraft engines.

This set of pipelines 110, 120, 130 is arranged and interconnected together such as according to the needs of the engines 430, the vacuum pump 410 is able to lead the fuel 300 available in the tank 200 via the first orifice 113 of the first pipeline 110, considered in the state of art as a suction point, to the engines 430 through the valve 420. Unfortunately, the localization of the first orifice 113 is strategically positioned in the lower part of the tank 200 in order to guarantee that the engine 430 is supplied with fuel 300 during its operation. The main difficulty met in this kind of disposition of the suction point, according to the state of art, is an inappropriate ingestion of water or dirt by the engine 430, which could lead to detrimental consequences for the engine 430.

The present invention wishes to overcome the disadvantages of the suction system 100 of the state of art by adding a retrofit technical solution, as shown in FIG. 2. The suction system 100 according to the invention comprises a flexible hose 150 comprising a first 151 and a second 152 extremity, the second extremity 152 comprising an orifice 154 configured to be connected to the first orifice 113 of the first pipeline 110 via a connection point 440. The first extremity 151 of the flexible hose 150 is fastened to a floating system 155 and comprises at least one orifice 153, such as the orifice 153, which becomes a suction point always able to supply the engine 430 from the upper layer 310 of fuel 300 available inside the tank 200, in order to avoid water and dirt from the lower layer 320. The set of orifices 153 presents a real advantage in order to avoid the blockage of the suction if one these orifices 153 was clogged because of the presence of dirt. This set of orifices 153 work consequently as a filter. Another advantage of this embodiment is to allow to the flexible hose 150 to follow, dynamically, the level of fuel 300 available in the tank 200 and particularly the best layer, the upper one 310.

In another embodiment, the connection point 440 is an articulation point, such that the hose 152 is able to move rotationally freely with respect to the first pipeline 110.

In another embodiment, the flexible hose 150 is retractable, such that when the first extremity 151 of the flexible hose 150 is moving down according to the level of fuel 300 available in the tank 200, the hose length is reducing. When the first extremity 151 of the flexible hose 150 is moving up according to the level of fuel 300 available in the tank 200, the hose length is increasing.

In another embodiment, the floating system 155 is a buoy.

In another embodiment, the first extremity 151 of the flexible hose 150 is only able to move vertically via a guiding element 156 inside the tank 200, while the level of fuel 300 available in the tank 200 changes.

In another embodiment, the guiding element 156 can be a rail, or a rod with a ring or a profile, the guiding element 156 being made from metal or composite material.

In another embodiment, the suction point of the first extremity 151 of the flexible hose 150 is located some centimeters below the floating system 155 in order to be sure that the suction point is fed with fuel 300 without air and potential dirt.

In another embodiment, the fuel tank 200 can be housed inside an aircraft wing or a HTP (Horizontal Tail Plane).

Another object of the invention is an Auxiliary Power Unit 430 fed with fuel 300 via a suction system 100 according to the invention.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Although advantages associated with certain embodiments of the invention have been described in the context of those embodiments, other embodiments may also exhibit such advantages. Additionally, none of the foregoing embodiments need necessarily exhibit such advantages to fall within the scope of the invention. Accordingly, the invention is not limited except as by the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fuel tank with a suction system, said tank configured to receive at least two layers of liquid, with a lower layer being denser than an upper layer, the upper layer comprising fuel, said suction system comprising:
a first pipeline comprising, respectively, a first and a second extremity, said extremities each comprising, respectively, an orifice,
a second pipeline comprising, respectively, a first and a second extremity, said extremities each comprising, respectively, an orifice,
a third pipeline comprising, respectively, a first and a second extremity, said extremities each comprising, respectively, an orifice,
a second orifice of the first pipeline being connected to a first orifice of the second pipeline via a vacuum pump,
a second orifice of the second pipeline being connected to a first orifice of the third pipeline via a valve,
a second orifice of the third pipeline being connected to a fuel engine,
a flexible hose comprising a first and a second extremity, said second extremity comprising an orifice configured to connect to a first orifice of the first pipeline via a connection point,
the first extremity of said flexible hose being fastened to a floating system and comprising at least one orifice, such that the flexible hose orifice is a suction point configured to supply the engine from the upper layer of fuel available within the tank, in order to avoid any water or dirt from the lower layer of liquid.

2. The fuel tank with a suction system according to claim 1, wherein the connection point is an articulation point, such that the hose is configured to move freely with respect to the first pipeline.

3. The fuel tank with a suction system according to claim 1, wherein the flexible hose is retractable, such that when the first extremity of the flexible hose moves down according to a level of the fuel in the tank, a length of the hose reduces, and when the first extremity of the flexible hose moves up according the level of the fuel in the tank, the hose length is increases.

4. The fuel tank with a suction system according to claim 1, wherein the floating system is a buoy.

5. The fuel tank with a suction system according to claim 1, wherein the first extremity of the flexible hose is confined to move only vertically via a fixed guiding element inside the tank, while the level of liquid within the tank changes.

6. The fuel tank with a suction system according to claim 1, wherein the fixed guiding element comprises a rail, a rod or a profile, made from metal or composite material.

7. The fuel tank with a suction system according to claim 1, wherein the suction point of the first extremity of the flexible hose is located between 1 and 3 centimeters below the floating system to be sure that the suction point is fed with fuel without air and without potential floating dirt.

8. The fuel tank with a suction system according to claim 1, wherein the fuel tank is configured to be housed inside an aircraft wing or a horizontal tail plane.

9. An auxiliary power unit fed with fuel via the fuel tank with a suction system according to claim 1.
